(19) United States
(12) Patent Application Publication
(10) Pub. No.: US 2007/0298951 A1
(43) Pub. Date: Dec. 27, 2007

(54) Wafer handling device

(75) Inventor: Michael Hofmann, Heuchelheim (DE)

Correspondence Address: SIMPSON & SIMPSON, PLLC, 5555 MAIN STREET, WILLIAMSVILLE, NY, 14221-5406, US

(73) Assignee: Vistec Semiconductor Systems GmbH, Weilburg (DE)

(21) Appl. No.: 11/818,704

(22) Filed: Jun. 15, 2007

(30) Foreign Application Priority Data
Jun. 24, 2006 (DE) 10 2006 029 003.8

(51) Int. Cl. B23Q 3/155

(52) U.S. Cl. 483/16

(57) ABSTRACT

A wafer handling device (10) comprises at least one tool component (12), a base rack (22) and a robot (20) for moving the wafers (14). In order to improve the accessibility of a wafer handling device (10), the robot (20) is mounted on a coupling rack (26) and with this coupling rack (26) is mounted on the base rack (22) independently of the tool component (12).

### CROSS REFERENCE TO RELATED APPLICATIONS

This patent claims priority from German patent application DE 10 2006 029 003.8, filed Jun. 24, 2006, which application is incorporated herein by reference.

### FIELD OF THE INVENTION

The present invention relates to a wafer handling device.

### BACKGROUND OF THE INVENTION

In the manufacture of semiconductors wafers are processed sequentially in a number of process steps during the manufacturing process, a plurality of identical, reoccurring structural elements, the so-called dies, being produced on one wafer. With increasing integration density the quality requirements demanded of the structures formed on the wafers also increases. In order to monitor the quality of these structures and to ensure precise positioning of the structures on the wafer during its manufacture, and in order to be able to identify any defects, the requirements relating to the accuracy and the reproducibility of the wafer-handling components and the processing steps are correspondingly high. In addition, extremely clean processing environments for the handling device are also necessary.

Standards intended to ensure this have therefore already been developed for methods of semiconductor processing and the device needed for this purpose. DE 10 2004 008 900 A1, for example, discloses a wafer handling device pertaining to this, which comprises a so-called device front-end module (EFEM), which uses a robot to take the wafers from their standard transport containers and to transfer them to stations for further processing or examination of the wafers. In addition to the robot for moving the wafers, such an EFEM usually has other components, so-called tool components, such as, in particular, toolports or pre-aligners for aligning the wafers to be fed in. The robot and the other components are firmly mounted in a rack, which although advantageous for the initial precise positioning of the robot then proves disadvantageous when ease of access to the robot is required. This is particularly the case when a repair is necessary, in which the robot or parts can then be replaced or repaired only under ergonomically very unfavourable conditions. If one of the existing components, such as the toolport of the EFEM, is out of adjustment, the known design construction proves a further disadvantage, since teaching of the entire system is thereby necessary.

### SUMMARY OF THE INVENTION

The object of the present invention, therefore, is to propose a wafer handling device which will allow processing to be configured more flexibly and will improve the ease of servicing. At the same time, the downtimes for the repair of a wafer handling device are to be reduced.

According to the present invention, this object is achieved by a wafer handling device with a tool rack with at least one tool component, a base rack and a robot for moving the wafers. The robot is mounted on a coupling rack and with this coupling rack is mounted directly on the base rack independently of the tool rack, and wherein the tool component together with the tool rack is connected to the base rack.

The wafer handling device according to the invention therefore comprises at least one tool component that is connected to the tool rack. The tool component may comprise, for example, one or more toolports, a pre-aligner or other modules for wafer processing of the wafer front or rear side or the wafer edge. A base rack is furthermore provided. The wafers are moved by means of a robot, the robot being mounted on a coupling rack. By means of the coupling rack the robot is mounted on the base rack independently of the tool rack.

The independent connection of the coupling rack to the base rack ensures that the robot remains fully accessible as one of the central components of the system. If the robot also has an integral control unit, this also increases the flexibility of the overall system, since the robot is then easily replaceable.

In a preferred embodiment of the invention a tool rack is connected to a tool component. The two together are connected to the base rack of the wafer handling device.

This connection is preferably easily detachable, thereby ensuring easy and convenient access to the robot and hence an easy, ergonomic replacement of the robot and other components.

In particular, the tool rack together with the tool component can be pivotally fixed to the base rack, so that the tool rack can be swivelled away from the base rack. It is likewise possible, to connect the tool rack to the base rack in such a way that the tool rack together with the tool component can be removed from the base rack, by means of a rail construction, for example.

The ease with which the tool rack can be removed from the base rack creates the facility for inspecting the wafer handling device so as to carry out servicing and repair work, which has advantages both for the tool rack itself and for the robot.

Another advantage of such a design construction is that swivelling the tool rack away or removing it from the base rack has no effect on the correct adjustment of the robot, so that the latter does not need to be readjusted after reconnecting the tool rack to the base rack. All that is required here is an adjustment to ensure that the co-ordinate axes of the individual components of the wafer handling device are at right angles. This in turn affords a considerable time advantage when starting the wafer handling device up again, thereby more rapidly making it available for use again.

With the device according to the invention it is thereby possible to ensure flexible docking. In addition the accessibility is simply improved. The necessary adjustment work can moreover be reduced, thereby shortening the set-up time. At the same time, an ergonomic handling in the event of repair is also ensured, since the robot is more easily accessible.

### BRIEF DESCRIPTION OF THE DRAWINGS

Further advantages and advantageous embodiments of the invention form the subject matter of the drawings appended and the descriptions of these, a representation true to scale having been dispensed with in the interests of greater clarity.

In the detailed drawings:

FIG. 1 schematically represents the basic construction of the wafer handling device according to the invention;

FIG. 2 shows a schematic three-dimensional view of a base rack;

FIG. 3 shows a schematic three-dimensional view of a tool component, which is connected to the tool rack; and,

FIG. 4 shows a schematic three-dimensional view of a robot with a coupling rack.

### DETAILED DESCRIPTION OF THE INVENTION

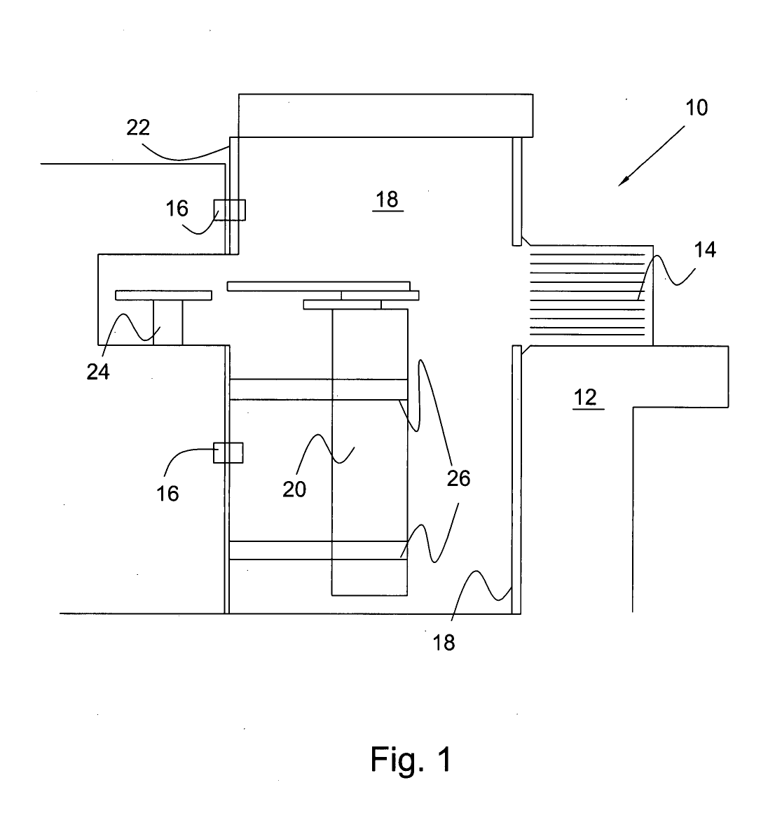

FIG. 1 schematically represents the basic construction of the wafer handling device 10 according to the invention. Here a so-called toolport is provided as tool component 12, on which a stack of wafers 14 is available to the wafer handling device 10. The toolport is connected to the tool rack 18. The wafers 14 are transported away from the wafer stack by the robot 20 and are transferred onto a wafer processing station 24 for processing or examination of the wafers 14. Here the robot 20 is attached by a coupling rack 26 to the base rack 22. The attachment of the coupling rack 26 is designed so that this is possible independently of the attachment of the tool rack 18 to the base rack 22.

The connection of the tool rack 18 to the base rack 22 via the articulations 16 where necessary allows the tool rack 18 together with the tool carrier 12 to be swivelled away from the base rack 22, so as to create a means of easy access to the robot 20. Alternatively, the tool rack 18 can also be attached to the base rack 22 in such a way that it can be removed together with the tool carrier 12. For this purpose a rail system, in particular, may be used, which serves as sliding device. In both cases, however, the coupling of the tool rack 18 to the base rack 22 is designed in such a way that the tool rack 18 together with the tool component 12 can be detached from the base rack 22, so that the position of the robot 20 remains unchanged. This obviates the need for a subsequent adjustment of the robot. When the tool rack 18 is reattached to the base rack 22, it is therefore merely necessary to check the correct alignment of the robot 20. It is here a matter of aligning the co-ordinate system 15 (or the machine axes) of the robot 20 relative to the coordinate systems 15 of the individual components. This means that the co-ordinate systems 15 must be parallel. The robot 20 itself can then learn the position of the other wafers from the position of one wafer in the toolport.

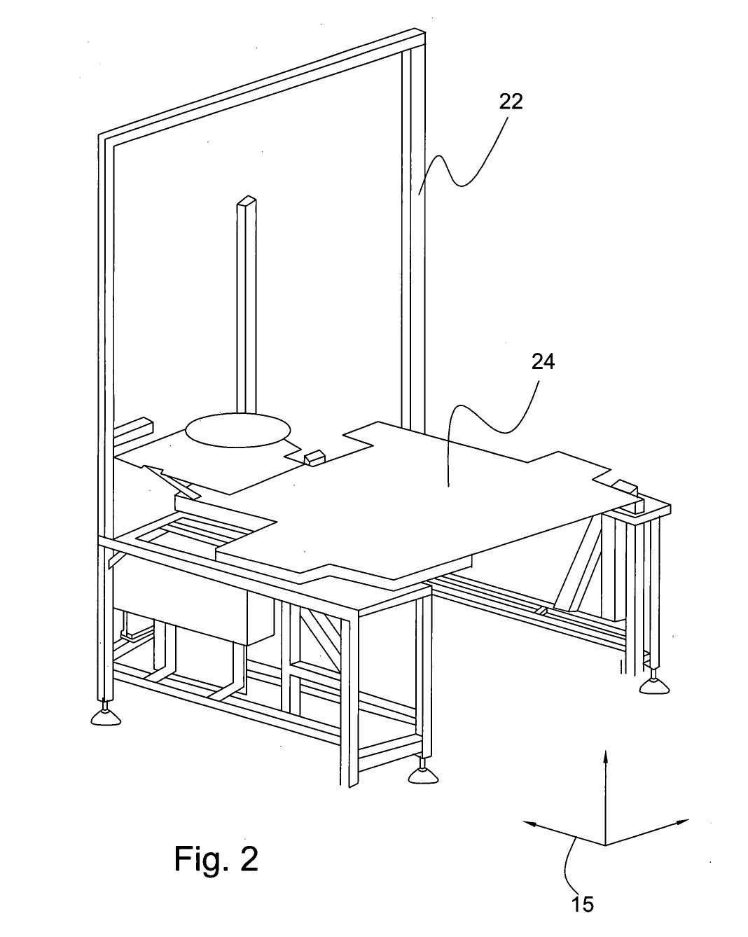

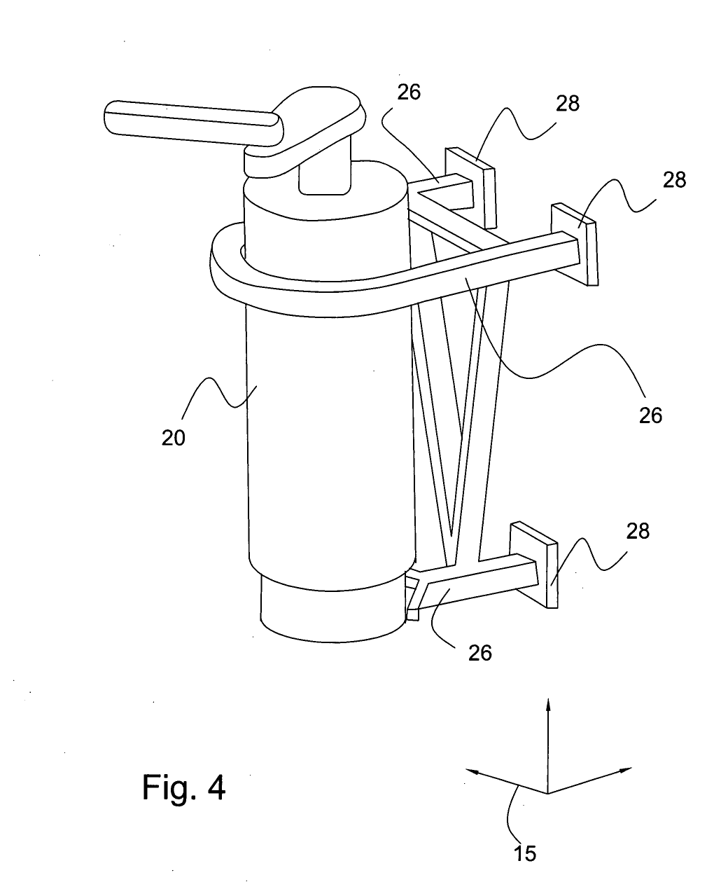

FIG. 2 shows a schematic three-dimensional view of a base rack 22. Here, on one side 23 of the base rack 22, space is provided for a wafer processing station 24, to which the wafers 14 are transferred by the robot 20. At a suitable point the robot 20 is attached to the base rack 22 by way of a separate coupling rack 26 (see FIG. 1 and FIG. 4), to which the robot 20 is connected. The attachment is made independently of the other components of the wafer handling device 10 and in such a way that the robot 20 is adjustable on base rack 22. This design construction ensures that the robot 20 can be changed rapidly and ergonomically, since it is now easily accessible. The adjustment of the robot 20 on the base rack 22 is in each case performed relative to the co-ordinate system 15 of the relevant tool components 12, but always on the base rack 22. This adjustment is therefore independent of work on the tool component 12, such as the toolport, or on other components in the tool rack 18.

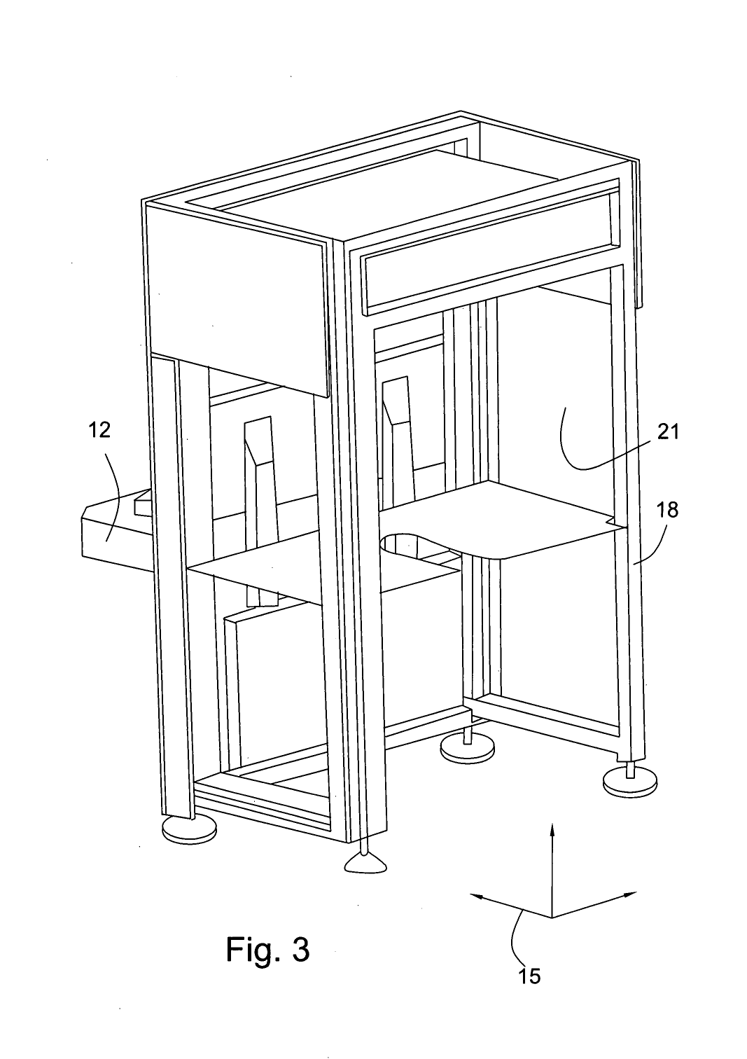

FIG. 3 shows a schematic three-dimensional view of a tool component 12 with the tool rack 18. The tool component 12 may, in particular, be a toolport, or a pre-aligner for preparing the defined feed delivery of the wafers 14 to the robot. The tool rack 18 is provided with suitable means for detachable coupling to the base rack 22. For this purpose, for example, an articulation 16 may be provided for pivotal connection, or a sliding device (not shown) may be provided, in order to be able to remove the tool rack together with the tool component 12 from the base rack 22 independently of the robot 20. It is thereby possible, for example, to make a side wall 21 of the tool rack 18 removable, so that it can be partially or entirely removed. Work can thereby easily be carried out inside the wafer handling device 10 or on the elements in the tool rack 18 itself without affecting the adjustment of the robot 20. This means that the tool rack 18 is always open to inspection. It is advantageous here, however, if the side wall 21 of the tool rack 18 can be opened like a door. Opening of the door on the side wall 21 can be controlled by way of an interlock. This is particularly important when there are moving parts inside the tool rack 18. This is necessary on safety grounds alone, in order to prevent the risk of injury to a user or personnel servicing the wafer handling device 10.

FIG. 4 shows a robot 20 with a coupling rack 26 fitted to it. The coupling rack 26 encloses the robot 20 and has attachment points 28, by means of which it can be attached to the base rack 22 of the wafer handling device 10. Since the coupling rack 26 provides support for the robot 20, the robot 20 can thereby be adjustably attached directly to the base rack. This is particularly advantageous when the robot 20 also comprises control electronics, since in this case a specific or even ideal robot can be selected for the respective application, and is easy to install and service.

The invention creates a wafer handling device 10, which can be divided into two components mechanically independent of one another: the coupling rack 26 with the robot 20 and the tool rack 18 with the tool components 12 attached to it. This division serves to eliminate the hitherto unfavourable, unergonomic handling that made servicing difficult and which was especially apparent in the event of repairs or when it was necessary to replace components.

What is claimed is:

1. A wafer handling device comprising: a tool rack with at least one tool component, a base rack and a robot for moving the wafers, wherein the robot is mounted on a coupling rack and with this coupling rack is mounted directly on the base rack independently of the tool rack, and wherein the tool component together with the tool rack is connected to the base rack.

2. The wafer handling device according to claim 1, wherein the tool rack is connected to the base rack by way of at least one articulation.

3. The wafer handling device according to claim 2, wherein the tool rack is connected to the base rack so that it can be swivelled away from the latter.

4. The wafer handling device according to claim 1, wherein the tool rack is connected to the base rack by way of a sliding device.

5. The wafer handling device according to claim 4, wherein the tool component can be removed from the base rack.

6. The wafer handling device according to claim 1, wherein the tool rack is connected to the base rack in such a way that, when the tool rack is removed or swivelled away from the base rack, the position of the robot remains unchanged.

7. The wafer handling device according to claim 1, wherein at least one side wall of the tool rack is of removable design, allowing access to the inside of the tool rack.
